(19) United States
(12) Patent Application Publication
(10) Pub. No.: US 2014/0272228 A1
(43) Pub. Date: Sep. 18, 2014

(54) BIODEGRADABLE PVC FILM FOR PHARMACEUTICAL PACKAGING AND PROCESS FOR ITS PREPARATION

(71) Applicant: BILCARE LIMITED, Maharashtra (IN)

(72) Inventors: Wilheim Morr KLAUS, West Grove, PA (US); Pifferi MARCO, Newark, DE (US); Ajith Sashidharan NAIR, Frazer, PA (US); Praful NAIK, Maharashtra (IN)

(73) Assignee: BILCARE LIMITED, Maharashtra (IN)

(21) Appl. No.: 14/249,987

(22) Filed: Apr. 10, 2014

Related U.S. Application Data
(63) Continuation of application No. PCT/IN2012/000672, filed on Oct. 10, 2012.

(30) Foreign Application Priority Data
Oct. 11, 2011 (IN) 2877/MUM/2011

(51) Int. Cl. A61J 1/00; B29C 43/24

(52) U.S. Cl. CPC A61J 1/00; B29C 43/24
USPC 428/36.4; 523/124; 264/78; 264/175

(57) ABSTRACT

A process for preparing a bio-degradable PVC based pharmaceutical grade thermo-formable film. The film is stable in aerobic conditions and is bio-degradable under anaerobic conditions. The bio-degradable PVC based pharmaceutical grade film has application in the blister packing of pharmaceutical formulations.

### REFERENCE TO RELATED APPLICATIONS

This application is a continuation application of International Application No. PCT/IN2012/000672, filed with the Indian Patent Office on Oct. 10, 2012 and claims priority to Indian Patent Application No. 2877/MUM/2011 filed with the Indian Patent Office on Oct. 11, 2011. The entire content of each of these applications is incorporated herein by reference.

### BACKGROUND

1. Field of the Invention

The present disclosure relates to an eco-friendly PVC film and a container prepared there from for the blister packing of pharmaceutical formulations. The present disclosure also relates to a process for the preparation of the eco-friendly film.

2. Description of the Related Art

Blister packaging is a popular packaging method for pharmaceutical solid dosage forms which is growing rapidly. PVC based films are commonly used for this purpose as they possess suitable properties for thermo formation and protection. However, PVC being difficult to decompose, there has been request for degradable material from the industry.

There have been developments of various eco-friendly and biodegradable films, however, till date a biodegradable PVC film has not been commercially available.

Also, non-PVC based materials lack the required thermal and chemical stability desirable for the manufacture of blister containers for pharmaceutical use.

Furthermore, the biodegradable material attempted to be developed in the prior art is susceptible to microbial growth at standard conditions. Presence of these types of material not only attracts microorganisms, but also adversely affects the physical properties and thermal/chemical stability required for this application.

It is because of this unique consideration that is specifically applicable in the realm of pharmaceutical packaging, standard method of producing a biodegradable or pseudo biodegradable film, by having certain starch/cellulose based polymers like polylactic acid or PVA or any such system in the formulation can not be applied as such for the preparation of blister containers for pharmaceutical formulations.

Recently, formulations for preparing biodegradable and compostable PVC which comprise pro-degradents have been disclosed in PCT Applications WO 2006/080955 and WO 2008/140552. The pro-degradents taught in these Applications comprise an adduct of an organotitanate or organozirconate or sulfonate with a hydrocarbon radical.

Though biodegradable and compostable films have been suggested in the prior art, the films are suitable only for the production of general purpose articles in the form of sheets for use in indoor and outdoor signs, bill boards, backdrops and wall coverings. The material of the prior art, however, suffers from many shortcomings and as such they are not suitable for the manufacture of pharmaceutical-grade blister packing materials. The material as suggested in the prior art has processability limitations and it can not be subjected to the rigors of a calendering process for preparation of PVC film.

There is, therefore, felt a need for a process for preparation of a biodegradable and compostable PVC film specifically adapted for the manufacture of blister containers for pharmaceutical formulations.

The present disclosure is particularly directed to overcome the shortcomings associated with the disclosures in the prior art.

### SUMMARY

Some of the non-limiting objects which at least one embodiment of this disclosure may achieve are:

It is an object of the present disclosure to provide a process for preparation of a bio-degradable PVC film.

It is another object of the present disclosure to provide a bio-degradable PVC film for pharmaceutical applications.

It is another object of the present disclosure to provide a bio-degradable PVC film which is rigid.

It is still another object of the present disclosure to provide a bio-degradable PVC film which is not susceptible to the attack of microorganism in normal aerobic conditions.

It is still another object of the present disclosure to provide a bio-degradable PVC film which is capable of undergoing biodegradation under anaerobic conditions.

It is still another object of the present disclosure to provide a bio-degradable PVC film which is robust to withstand the environmental and mechanical stress which the film can experience during all stages of its processing.

It is another object of this disclosure to suggest a process for the manufacture of biodegradable PVC film and blister packs for pharmaceutical use made from these packs.

These and other objects of the present disclosure are to a great extent dealt in the disclosure.

In accordance with one aspect of the present disclosure there is provided a process for preparing a bio-degradable PVC based pharmaceutical grade thermo-formable film, said process comprising the following steps:
a. mixing pharmaceutical grade PVC resin, at least one copolymer, at least one impact modifier, bio pro-degradent, at least one processing aid, and at least one stabilizer in a mixer to obtain a mixed batch of ingredients;
b. extruding the mixed batch of ingredients in an extruder at a screw speed ranging between 2 rpm and 15 rpm and temperature ranging between 55° C. and 70° C. to obtain fluxed polymeric flakes; and
c. calendering the polymeric flakes by subjecting them to at least two calender rolls maintained at temperatures ranging between 100° C. and 250° C. to obtain a bio-degradable PVC based pharmaceutical grade thermo-formable film,
wherein, said film is stable in aerobic conditions and is bio-degradable under anaerobic conditions.

Typically, the method step of mixing further comprises adding at least one pigment in the mixed batch.

Typically, the method step of mixing further comprises adding titanium dioxide in the mixed batch.

Typically, the method step of extruding comprises providing a difference between the torque of the feeder screw and torque of the output screw of the extruder which causes generation of pressure and heat on the mixture, resulting in fluxing of the material fed to the extruder.

Typically, the percentage difference between the torque of the feeder screw and torque of the output screw ranges between 5 and 20.

Preferably, the percentage difference between the torque of the feeder screw and torque of the output screw ranges between 8 and 16.

Typically, the pharmaceutical grade PVC resin is at least one selected from the group consisting of PVC suspension resin and PVC homopolymer suspension resin.

Typically, the copolymer is Vinyl Chloride/Vinyl Acetate copolymer.

Typically, the impact modifier is at least one selected from the group consisting of methylmethacrylate-butadiene-styrene-acrylic copolymer and acrylic modifier.

Typically, the bio pro-degradent is Ethylene-Vinyl Acetate copolymer with organoleptic additives.

Typically, the amount of bio pro-degradent ranges between 0.01% and 20% with respect to the mass of the film, preferably, 0.1% and 10.0% with respect to the mass of the film.

Typically, the processing aid is at least one selected from the group consisting of anti-blocking/slipping agents, antistatic agents, lubricants, release agents, anti-sticking agents and melt strength/viscosity balancing agents.

Typically, the stabilizer is at least one selected from the group consisting of polymer and soybean stabilizer.

Typically, the at least two calender rolls are arranged at a distance ranging between 0.01 mm and 50 mm from each other.

Typically, the calender rolls are arranged in a cross-axial or bending position with respect to each other.

In accordance with another aspect of the present disclosure there is provided a bio-degradable PVC based pharmaceutical grade thermo-formable film obtained by a process of the present disclosure, said film comprising:
i. a pharmaceutically grade PVC resin, ii. a copolymer, iii. at least one impact modifier, iv. a bio pro-degradent, v. at least one processing aid, vi. optionally, a titanium dioxide, vii. at least one stabilizer and viii optionally, at least one pigment,
wherein, said film is stable in aerobic conditions and is bio-degradable under anaerobic conditions.

Typically, the pharmaceutical grade PVC resin is at least one selected from the group consisting of PVC suspension resin and PVC homopolymer suspension resin.

Typically, the copolymer is Vinyl Chloride/Vinyl Acetate copolymer.

Typically, the impact modifier is at least one selected from the group consisting of methylmethacrylate-butadiene-styrene-acrylic copolymer and acrylic modifier.

Typically, the bio pro-degradent is Ethylene-Vinyl Acetate copolymer with organoleptic additives.

Typically, the amount of bio pro-degradent ranges between 0.01% and 20% with respect to the mass of the film, preferably, 0.1% and 10.0% with respect to the mass of the film.

Typically, the processing aid is at least one selected from the group consisting of anti-blocking/slipping agents, antistatic agents, lubricants, release agents, anti-sticking agents and melt strength/viscosity balancing agents.

Typically, the stabilizer is at least one selected from the group consisting of polymer and soybean stabilizer.

Typically, the PVC film is rigid.

In accordance with another aspect of the invention there is provided a blister pack made from the PVC film.

### BRIEF DESCRIPTION OF THE DRAWINGS

The above and other aspects, features and advantages of certain embodiments will be more apparent from the following detailed description taken in conjunction with the accompanying drawings, in which:

FIG. 1 illustrates the process for preparing the bio-degradable PVC based pharmaceutical grade thermo-formable film of the present disclosure, wherein, a=mixing and fluxing unit, b=conveyor belt unit, c=calender rolls, d=post calender unit, and e=winder unit;

FIG. 2 illustrates the transmission rate data graph of the bio-degradable PVC film prepared in Example 1;

FIG. 3 illustrates the FTIR graph of side A of the bio-degradable PVC film prepared in Example 1;

FIG. 4 illustrates the FTIR graph of side B of the bio-degradable PVC film prepared in Example 1;

FIG. 5 illustrates the heat seal strength of the bio-degradable PVC film prepared in Example 1; and

FIG. 6 illustrates the tensile strength of the bio-degradable PVC film prepared in Example 1.

### DETAILED DESCRIPTION

The following detailed description of certain embodiments will be made in reference to the accompanying drawings. In the detailed description, explanation about related functions or constructions known in the art are omitted for the sake of clearness in understanding the concept of the invention, to avoid obscuring the invention with unnecessary detail.

In accordance with one aspect of the present disclosure there is provided a process for preparing a bio-degradable and compostable PVC based pharmaceutical grade thermo-formable film specifically suitable for the manufacture of blister container for pharmaceutical formulations.

The process for preparing a biodegradable and compostable PVC film is specifically adapted for pharmaceutical applications, especially the preparation of blister containers in accordance with the present disclosure.

In the mixing step, the ingredients comprising PVC resin, copolymer, at least one impact modifier, bio pro-degradent, at least one processing aid, at least one stabilizer and optionally, titanium dioxide is added to a mixer and mixed thoroughly to ensure that all the ingredients are mixed uniformly prior to feeding into the extruder. Further, at least one pigment may be added depending upon the need and requirement during or after the mixing step. The pharmaceutical grade PVC resin is at least one selected from the group consisting of PVC suspension resin and PVC homopolymer suspension resin. The copolymer may be Vinyl Chloride/Vinyl Acetate copolymer.

Further, the impact modifier employed is at least one selected from the group consisting of methylmethacrylate-butadiene-styrene-acrylic copolymer and acrylic modifier.

The stabilizer in accordance with the present disclosure is at least one selected from the group consisting of a polymer and soyabean stabilizer.

The major equipment employed for carrying out this method step includes but is not limited to turbo (heated) mixer and cooling mixer.

The mixed batch is continuously fed into an extruder. The extruder produces fluxed material which is as a result of the conversion of the powdered batch into fluid material. The extruder creates the fluxed material with a minimum of entrapped air but without overheating or overworking the material.

The method step of extrusion is carried out in a kneader, typically a ko-kneader (KK) which has three primary process adjustments i.e., power feeder torque, screw speed and temperature. The power feeder is a hopper with an internal auger mounted atop the KK which supplies powdered blend to the KK. Increase in the power feeder speed forces more blend into the KK, which increases the torque. Further, changing the speed of the KK screw changes the rate of output. The percentage difference between the torque of the feeder screw and the torque of the output screw causes generation of pressure and heat on the mixture and therefore fluxing of the material which comes out in the form of flakes to be fed to the calender. The KK output is matched with the calender input to maintain a consistent level. The KK has three temperature control zones. The temperature of each zone affects the fluxing of the powdered blend and different ingredients require different temperature settings.

The bio pro-degradent typically employed for the preparation of the PVC film of the present disclosure comprises Ethylene-Vinyl Acetate copolymer with organoleptic additives. The presence of the bio pro-degradent adversely affects the gelification process of the composite and makes extrusion process very difficult. In accordance with the process of the present disclosure, the gelification of the composition is carried out by controlling specific processing parameters during extruding. These parameters include power torque, speed and temperature. The high torque ensures the desired level of gelification whereas the optimum temperature range during the process of the present disclosure is such that it does not allow the film to become hazy. The mixed batch is fluxed by applying power feeder torque difference ranging between 5% and 20%, screw speed ranging between 2 rpm and 15 rpm and temperature ranging between 55° C. and 70° C. to obtain flakes. In accordance with the process of the present disclosure, the torque difference between the feeder screw and the output screw, particularly, ranges between 8% and 16%. In accordance with an exemplary embodiment of the present disclosure if the input feeder power is “x” then the power of the output and therefore the speed ranges between “(95/100)x” and “(80/100)x.”

In accordance with the process of the present disclosure, the temperature of the mixture is lowered by 3° C. to 5° C. in order to avoid any degradation of the additive.

The extruded polymeric flakes are then made to fall on heated calender rolls where it melt and forms a film. Calendering converts the fluxed material into films of required thickness by passing through multiple heated and cooled rolls. The calender rolls have three primary means of adjustment i.e., temperature, gap and speed. In addition, cross-axis or roll bending adjustments may also be used to fine-tune the film profile. Cross-axis and roll bending offset the characteristic “oxbow” profile associated with calendered film.

Temperature parameters of calender rolls affect the viscosity of the material, which relates to behavior in the banks and overall surface quality. Differences in temperature from roll to roll may be used to facilitate the transfer of material from one roll to the next. Too high a temperature may cause degradation (discoloration, decomposition) of the material as well as a tendency to stick to the calender rolls whereas too low temperature may result in higher air entrapment, more visible flow lines, and overall poor surface quality. Further, high temperature makes the composition rigid and affects the calendering process where the polymer particles get burnt resulting in the formation of black particles. This rigidity also creates non-uniformity of the calendered films and affects thickness uniformity which is essential for blister packing application. This makes the film unsuitable for pharmaceutical applications, and especially, for the preparation of blister containers for pharmaceutical formulations.

The inventors of the present disclosure have employed processing aids to nullify the rigidity effect due to the presence of bio pro-degradent additives, and thus reduce the rigidity of the films. The additives as employed in accordance with the process of the present disclosure also ensure uniformity of the film. Furthermore, these additives obviate the possibility of the formation of black particles during processing and thereby ensuring the preparation of films that are suitable for pharmaceutical applications, especially, for the preparation of blister containers for pharmaceutical formulations. Further, to achieve optimum quality film the temperature of the calender rolls is maintained between 100° C. and 250° C. as the take-off and cooling roll temperatures affect shrinkage characteristics and final thickness profile.

The thickness of the film depends on the gap between the two calender rolls. The gap between the two calender roll ranges between 0.01 mm and 50 mm.

Rotating speeds of the calender rolls affect overall line throughput and surface quality due to residence time on the calender rolls.

The post-calender section is adjustable for temperature and speed. The goal of both calender and post-calender controls is to produce film of uniform thickness with minimal surface imperfections and acceptable shrinkage characteristics.

The film obtained by the process of the present disclosure is stable in aerobic conditions whereas bio-degradable under anaerobic conditions.

The film obtained is then cooled prior to winding into roll form by employing a winder. The equipment employed for carrying out this process of extrusion and calendering includes but are not limited to extruder (kneader), calender rolls (heated), post calender rolls (heat & cold) and winders.

In another aspect of the present disclosure there is provided a bio-degradable PVC based pharmaceutical grade thermo-formable film prepared in accordance with the process of the present disclosure.

The PVC film envisaged in accordance with the present disclosure is compostable and anaerobically biodegradable under a landfill. Further, the PVC film of the present disclosure is also made in the form of a “paper lookalike” feel, texture and appearance.

In accordance with one of the embodiment of the present disclosure there is provided a generally pharmaceutical grade thermoforming PVC film composition comprising: i) PVC resin; ii) copolymer; iii) at least one impact modifier iv) bio pro-degradent; v) at least one processing aid; vi) optionally, titanium dioxide and vii) at least one stabilizer and viii) optionally, at least one pigment. The film of the present disclosure is stable in aerobic conditions and is bio-degradable under anaerobic conditions.

The bio pro-degradent employed for the preparation of the PVC film of the present disclosure includes but is not limited to Ethylene-Vinyl Acetate copolymer with organoleptic additives. The presence of bio pro-degradent in specific proportions renders the PVC film of the present disclosure compliant for making blister container for pharmaceutical formulations while retaining its biodegradability characteristics under anaerobic conditions. The amount of the bio pro-degradent in the PVC film of the present disclosure ranges between 0.01% to 20%, preferably between 0.1% to 10% with respect to the mass of the film. The bio pro-degradent helps microbes to break down the long polymer molecule under anaerobic conditions, especially under the ground and mineralize it into CO₂, methane, water and biomass.

The processing aid in accordance with the present disclosure is at least one selected from the group consisting of anti-blocking/slipping agents, antistatic agents, lubricants, release agents, anti-sticking agents and melt strength/viscosity balancing agents.

The PVC resin used for making of the film of the present disclosure is specifically devoid of any plasticizer as plasticizers tend to leach/migrate to the substance in contact. Therefore, as per the regulatory requirement, pharmaceutical grade PVC film has to be a rigid plasticizer free film.

Mobility in the polymer matrix is essential for biodegradability. The PVC film of the present disclosure comprises a polymer system which ensures internal mobility in the polymer matrix and allows the functioning of the bio pro-degrade system without the use of a plasticizer.

In accordance with yet another aspect of the present disclosure there is provided a complete biodegradable blister container prepared from the PVC film of the present disclosure as the cavity forming material and a lidding foil which is a paper based.

The disclosure will now be described with the help of following non-limiting examples.

### EXAMPLES

### Example I

### Preparation of Biodegradable and Compostable White Opaque PVC Film of 250 Micron

A. Batch Mixing Operation:

255.7 kg of PVC suspension resin, 49.90 kg of Vinyl chloride/vinyl Acetate Copolymer, 14.52 kg of Methylmethacrylate-Butadiene-Styrene Terpolymer, 39.50 kg of PVC emulsion polymer, 1.50 kg of polyol ester based lubricant, 0.5 kg of Amide of ethylenediamine, 2.05 kg of Polyvinyl chloride, 2.06 kg of Acrylic polymer processing aid, 2.42 kg of butadiene/methylmethacrylate/styrene, 4.00 kg of Bio Pro-degradent (Eco-pure™ manufactured by Bio-tech Environmental, LLC), 11.40 kg of Titanium dioxide, 3.75 kg of Polymer stabilizer and 3.04 kg of Partial esters of fatty acids with glycerol were added to the batch mixing system from the respective storage system using programmable logic controlled material dosage/discharge systems and mixed to obtain a thoroughly mixed batch of ingredients.

B. Calender Operation

The following process protocol was followed for carrying out the calendering operation.

| PROCESS STEP | EQUIPMENT | PARAMETER | UNIT | VALUE |
|---|---|---|---|---|
| Extruder | Ko-Kneader | Difference | % | 10.6 |
| | | between the | | |
| | | torque of the | | |
| | | feeder screw | | |
| | | and the torque of | | |
| | | the output screw | | |
| | | Screw speed | rpm | 7.6 |

| | | | | |
|---|---|---|---|---|
| Calendering | Temperature | Cylinder 1 | ° C. | 166 |
| | Speed | | m/min | 15.4 |
| | Temperature | Cylinder 2 | ° C. | 168 |
| | Speed | | m/min | 16.5 |
| | Temperature | Cylinder 3 | ° C. | 175 |
| | Speed | | m/min | 17.7 |
| | Temperature | Cylinder 4 | ° C. | 178 |
| | Speed | | m/min | 19.4 |
| | Temperature | Cylinder 5 | ° C. | 154 |
| | Speed | | m/min | 23.0 |
| Winder | Web tension | | (dN) | 325 |

The process is followed as below
Set the power, speed of the KK screw and the temperature of the three zones to the required level.
Continuously feed the mixture of ingredients produced at the batch mixing operation to Ko-Kneader.
Fine tune the power feeder torque difference, speed and temperature of KK as per the process protocol so that flakes come out uniformly.
Set the gap, speed, and temperature of the calender rolls to the required level as per the process protocol. The parameter setting should also consider thickness, gloss, clarity and surface roughness requirement.
Start feeding the fluxed materials to the calender rolls.
Fine tune the parameters, gap, speed and the temperature of each calender roll as per the process protocol so that the film with required thickness, clarity and gloss comes out at the end.
Rewind the formed film in to rolls with the specified tension.

The Calender roll gaps provided the initial thickness control of the material and final thickness was determined by draw at the take-off rolls.

C. Post Calender Operations.

These master rolls further can be slit into small rolls.

D. Test Data

The Bio degradable film thus produced is tested for following properties to prove its application for blister packing application.

1. The physical and thermo mechanical properties for the application of blister packing,
2. Blister forming machine trials,
3. Food and drug contact application compliances, and
4. Biodegradability tests.

### Results:

### 1. The Physical and Thermo Mechanical Properties for the Application of Blister Packing

| | | | | 250 Micron Bio- | Specification of | |
|---|---|---|---|---|---|---|
| | | | | PVC film as | General Bilcare | |
| Sr. | | Test | | prepared in | 250 Micron PVC | |
| No | Parameters | Method | Unit | Example I | film | |
| 1 | Total Thickness | DIN 53370 | Micron | 249 | 250 ± 5% | |
| 2 | Total GSM | DIN EN | GSM | 346 | 345 ± 5% | |
| | | ISO 2286 | | | | |
| 3 | Impact Strength | ASTM | gm | 1290 | 350 | min. |
| | | D1709 | | | | |
| 4 | Specific Gravity | In-house | gm/cc | 1.38 | 1.38 ± 10% | |
| | Opaque | | | | | |
| 5 | Average Yield | In-house | m²/kg | 2.90 | 2.90 | |
| | Opaque | | | | | |
| 6 | Tensile Strength | ASTM | Kg/cm² | | | |
| | Longitudinal | D882 | | 457.92 | 400 | min |
| | Transverse | | | 540.92 | 400 | min |
| 7 | Peak Elongation | ASTM | % | | | |
| | Longitudinal | D882 | | 3.62 | 4 | Min |
| | Transverse | | | 3.79 | 4 | Min |
| 8 | Dimensional | ASTM | % | | | |
| | Stability | D1204 | | | | |
| | Longitudinal | | | −9 | −7 | max |
| | Transverse | | | +2 | +2 | max |
| 9 | Heat Seal | In-house | Kgf/cm | 0.774 | 0.30 | min |
| | Strength (PVC to | | | | | |
| | Al. foil) | | | | | |

The physical and thermo mechanical properties of the bio-degradable PVC film prepared in accordance with the process of the present disclosure are at par with the non-degradable 250 microns PVC film.

### 2. Blister Forming Machine Trials

Thermoforming trials were taken on rotary vacuum forming as well flat pressure forming thermoforming machines with various cavity sizes and found that it perform exactly the same as the regular thermoforming PVC films. The thermoforming parameters remain the same with that of regular films.

| | | | | 250 | Thermoforming |
|---|---|---|---|---|---|
| | | | | Micron Bio- | temperature of |
| | | | | PVC film as | General Bilcare |
| Sr. | | Test | | prepared in | 250 Micron |
| No | Parameters | Method | Unit | Example I | PVC film |
| 1 | Thermo | In-house | ° C. | 155-158° C. | 155-158° C. |
| | formability in | | | | |
| | rotary vacuum | | | | |
| | forming machine | | | | |
| | at 20-25 Inches | | | | |
| | of vacuum | | | | |
| 2 | Thermo | In-house | ° C. | 110-125° C. | 110-125° C. |
| | formability in flat | | | | |
| | bed pressure | | | | |
| | forming machine | | | | |
| | at 5-6 Kg | | | | |
| | pressure | | | | |

Thermo-formability of the bio-degradable PVC film prepared in accordance with the process of the present disclosure is at par with the non-degradable 250 microns PVC film.

### 3. Food and Drug Contact Material Compliances

| | | | | 250 Micron Bio- | Specification of |
|---|---|---|---|---|---|
| | | | | PVC film as | General Bilcare |
| Sr. | | Test | | prepared in | 250 Micron PVC |
| No | Parameters | Method | Unit | Example I | film |
| 1 | Toxicity Test | USP | | Non-toxic | Non-toxic |
| | | Current Ed. | | | |
| 2 | VCM content | 2002/72/EC | ppm | <1 | <1 |
| 3 | Global migration | 2002/72/EC | ppm | 5.1 | <60 |
| 4 | Average WVTR | ASTM | grams/m²/ | 3.72 | |
| | @ 90% RH at | F1249 | 24 hr. | | |
| | 38° C. | | | | |
| 5 | Average OTR @ | ASTM | cc/m²/24 hr. | 17.322 | |
| | 0% RH at 23° C. | D3985 | | | |
| 6 | FTIR | In-house | — | Complies | Complies |
| 7 | Heavy Metal | | | | |
| | Analysis | | | | |
| A | Cadmium | ICP- | ppm | <1 | <1 |
| B | Barium | OES/AES | | <1 | <1 |
| C | Iron | | | 2 | 2 |
| D | Lead | | | <1 | <1 |
| E | Arsenic ppm | | | <1 | <1 |
| F | Antimony ppm | | | <1 | <1 |
| G | Chromium | | | <1 | <1 |
| H | Mercury | | | <1 | <1 |
| I | Tin | | | 10 | 10 |
| J | Zinc | | | 1 | 1 |

Food and drug contact material compliances of the bio-degradable PVC film prepared in accordance with the process of the present disclosure is at par with the non-degradable 250 microns PVC film.

4. Biodegradability tests:

Determining anaerobic biodegradation of plastic materials under high solids anaerobic digestion conditions

### Inoculum Source:

Organic Compost—McEnroe Organic Farms, Millerton, N.Y. Mattabassit Waste Treatment Facility Anaerobic Digestion

| | |
|---|---|
| Solid Content | 22% |
| pH | 8.2 |
| Volatile Fatty Acids | 0.7 g/kg |
| Ammonia Nitrogen | 1.0 mg/kg |
| Volatile Solids | 24.9% |

Procedure:
1. Three weighed replicates of the test material were prepared by placing them into 1000 grams of inoculum in containers which were then attached to the gas measuring devices. Incubation temperatures of 52±2° C. were maintained by placing the containers in temperature controlled incubators.
2. Three blanks containing only inoculum, were prepared as described in (1) above, as were three positive controls each containing 20 grams of thin layer grade cellulose. Three negative controls were also run utilizing untreated samples supplied by Northeast Laboratories.
3. Samples were incubated for forty five days in the dark, or at times, diffused light. Gas volumes were determined daily. Carbon Dioxide and Methane concentration were also determined. Temperature and room atmospheric pressures were monitored during the course of incubation.

The results are shown in the following tables.

### Gas Production Data—Samples

| | 250 Micron Bio- | | | | | | | | | | | |
|---|---|---|---|---|---|---|---|---|---|---|---|---|
| | PVC film as prepared | | | Negative Control | | | Positive Control | | | | | |
| | in Example I | | | PE | | | Cellulose | | | Inoculum Control | | |
| Day | A | B | C | A | B | C | A | B | C | A | B | C |
| Totals | 9473 | 10659 | 9877 | 3609 | 4435 | 3992 | 15662 | 18075 | 16348 | 3867 | 3180 | 3950 |
| Days 1-30 | | | | | | | | | | | | |
| 31 | 25 | 25 | 50 | 155 | 180 | 150 | 185 | 150 | 205 | 40 | 50 | 65 |
| 32 | 25 | 25 | 50 | 155 | 180 | 150 | 185 | 150 | 205 | 40 | 50 | 65 |
| 33 | 42 | 106 | 85 | 32 | 106 | 74 | 53 | 106 | 32 | 32 | 42 | 53 |
| 34 | 116 | 129 | 110 | 16 | 97 | 48 | 113 | 90 | 90 | 32 | 32 | 48 |
| 35 | 116 | 129 | 110 | 16 | 97 | 48 | 113 | 90 | 90 | 32 | 32 | 48 |
| 36 | 116 | 129 | 110 | 16 | 97 | 48 | 113 | 90 | 90 | 32 | 32 | 48 |
| 37 | 274 | 274 | 205 | 34 | 71 | 68 | 205 | 171 | 171 | 102 | 102 | 154 |
| 38 | 274 | 274 | 205 | 34 | 71 | 68 | 205 | 171 | 171 | 102 | 102 | 154 |
| 39 | 274 | 274 | 205 | 34 | 71 | 68 | 205 | 171 | 171 | 102 | 102 | 154 |
| 40 | 40 | 50 | 200 | 50 | 50 | 50 | 100 | 100 | 130 | 70 | 80 | 20 |
| 41 | 51 | 51 | 44 | 17 | 13 | 27 | 68 | 68 | 68 | 137 | 68 | 120 |
| 42 | 51 | 51 | 44 | 17 | 13 | 27 | 68 | 68 | 68 | 137 | 68 | 120 |
| 43 | 51 | 51 | 44 | 17 | 13 | 27 | 68 | 68 | 68 | 137 | 68 | 120 |
| 44 | 69 | 87 | 52 | 17 | 0 | 24 | 52 | 52 | 62 | 0 | 13 | 17 |
| 45 | 69 | 87 | 52 | 17 | 0 | 24 | 52 | 52 | 62 | 0 | 13 | 17 |
| 46 | 0 | 10 | 0 | 50 | 20 | 50 | 50 | 50 | 30 | 30 | 10 | 10 |
| 47 | 9 | 9 | 9 | 28 | 15 | 38 | 67 | 57 | 67 | 28 | 19 | 38 |
| Totals | 11075 | 12420 | 11452 | 4314 | 5529 | 4981 | 17564 | 19779 | 18128 | 4920 | 4063 | 5201 |

| | | | | |
|---|---|---|---|---|
| Averages | 11649 | 4941 | 18490 | 4728 |

### Methane and Carbon Dioxide Readings

| | 250 Micron Bio- | | | | | | | |
|---|---|---|---|---|---|---|---|---|
| | PVC film as | | | | | | | |
| | prepared in | | Negative Control | | Positive Control | | | |
| | Example 1 | | 100 % PE Plastic | | Cellulose | | Inoculum Control | |
| Day | | Carbon | | Carbon | | Carbon | Carbon | |
| % | Methane | Dioxide | Methane | Dioxide | Methane | Dioxide | Dioxide | Methane |
| Average | % | % | % | % | % | % | % | % |
| Averages | 25.7% | 22.2% | 20.5% | 17.6% | 55% | 35.2% | 25.2% | 23% |
| Days 1- | | | | | | | | |
| 30 | | | | | | | | |
| 34 | 26% | 18% | 18.4% | 10.2% | 49% | 38.4% | 22% | 15.7% |
| 38 | 25% | 15% | 13.1% | 11.6% | 51% | 39.1% | 24% | 13.6% |
| 43 | 25% | 17% | 17.4% | 11.2% | 48% | 32.3% | 20% | 13.5% |
| Average | 25.6% | 20.4% | 24.9% | 15.4% | 53.1% | 35.7% | 24.1% | 20.1% |

### Calculations of Results

| | | Average | Methane | | | Carbon Dioxide | | | | |
|---|---|---|---|---|---|---|---|---|---|---|
| | Average | Gas | | | (Wt) | | | (Wt) | Total | |
| | Weight | Vol. | | | C | | | C | CH4 + | Sample- |
| Sample | grams | (mL) | (%) | (mL) | (grams) | (%) | (mL) | (grams) | CO2 | Inoculum= |
| 250 Micron | 25 | 11649 | 25.6 | 2982 | 1.6 | 20.4 | 2376 | 1.3 | 2.9 | 1.8 |
| Bio-PVC film | | | | | | | | | | |
| as prepared | | | | | | | | | | |
| in Example 1 | | | | | | | | | | |
| Negative | 25 | 4941 | 24.9 | 1230 | 0.7 | 15.4 | 761 | 0.4 | 1.1 | 0 |
| Control | | | | | | | | | | |
| Positive | 20 | 18490 | 53.1 | 9818 | 5.3 | 35.7 | 6601 | 3.5 | 8.8 | 7.7 |
| Control | | | | | | | | | | |
| Inoculum | 1000 | 4728 | 24.1 | 1140 | 0.6 | 20.1 | 950 | 0.5 | 1.1 | |
| Control | | | | | | | | | | |

Results (Average of 3)

| | Gaseous | | |
|---|---|---|---|
| | Carbon | Theoretical | (%) Biodegradation |
| | Recovered | Grams | Days 1-45 |
| 250 Micron Bio-PVC | 1.8 | 9.61 | 18.7% |
| film as prepared in | | | |
| Example 1 | | | |
| Negative Control | 0 | 21.4 | 0% |
| Positive Control | 7.7 | 8.8 | 87.5% |

The PVC film of the present disclosure has shown 18.7% biodegradation after 45 days of testing under the method ASTM D5511-02. The results support the suitability of the product for the blister packing application. It also depicts the biodegradation of the film.

### Example II

### Preparation of Biodegradable and Compostable Glass Clear PVC Film of 250 Micron

A. Batch Mixing Operation:

449.00 kg of PVC suspension resin, 23.600 kg of Methylmethacrylate-Butadiene-Styrene-Acrylic copolymer, 0.491 kg of Triple Pressed Stearic Acid Veg, 0.491 kg of Mg-Silicate based talc, 2.360 kg of Soyabean stabilizer, 4.910 kg of Amide of Ethylenediamine, 4.420 kg of Polyvinyl chloride, 1.970 kg of Acrylic polymer processing aid, 3.440 kg of Methylmethacrylate-Butadiene-Styrene processing aid, 3.440 kg of Bio Pro-degradent (Eco-pure™ manufactured by Bio-tech Environmental, LLC), 1.180 kg of Fatty acid ester of poly functional alcohols and 4.420 kg of Polymer stabilizer were added to the batch mixing system from the respective storage system using programmable logic controlled material dosage/discharge systems and mixed to obtain a thoroughly mixed batch of ingredients.

B. Calender Operation:

The following process protocol as developed by the inventors of the present disclosure was followed for carrying out the calendering operation.

| PROCESS STEP | EQUIPMENT | PARAMETER | UNIT | VALUES |
|---|---|---|---|---|
| Extruder | Ko-Kneader | Difference | % | 10.19 |
| | | between the | | |
| | | torque of the | | |
| | | feeder screw and | | |
| | | the torque of the | | |
| | | output screw | | |
| | | Screw speed | Rpm | 17.6 |

| | | | | |
|---|---|---|---|---|
| Calendering | Temperature | Cylinder 1 | ° C. | 174 |
| | Speed | | m/min | 20.3 |
| | Temperature | Cylinder 2 | ° C. | 177 |
| | Speed | | m/min | 22.3 |
| | Temperature | Cylinder 3 | ° C. | 196 |
| | Speed | | m/min | 24.7 |
| | Temperature | Cylinder 4 | ° C. | 205 |
| | Speed | | m/min | 28.1 |
| | Temperature | Cylinder 5 | ° C. | 162 |
| | Speed | | m/min | 33.5 |
| Winder | Web tension | | (dN) | 350 |

The film was prepared by the process as described in Example I.

C. Test Data

The Bio degradable film thus produced is tested for following properties to prove its application for blister packing application.

1. The physical and thermo mechanical properties for the application of blister packing,
2. Blister forming machine trials, and
3. Biodegradability tests.

Results:

### 1. The Physical and Thermo Mechanical Properties for the Application of Blister Packing

| | | | | 250 Micron Bio- | Specification of | |
|---|---|---|---|---|---|---|
| | | | | PVC film as | General Bilcare | |
| Sr. | | Test | | prepared in | 250 Micron PVC | |
| No | Parameters | Method | Unit | Example II | film | |
| 1 | Total Thickness | DIN 53370 | Micron | 253 | 250 ± 5% | |
| 2 | Total GSM | DIN EN | GSM | 338 | 340 ± 5% | |
| | | ISO 2286 | | | | |
| 3 | Impact Strength | ASTM | gm | 1200 | 350 | min. |
| | | D1709 | | | | |
| 4 | Specific Gravity | In-house | gm/cc | 1.35 | 1.35 ± 5% | |
| | Opaque | | | | | |
| 5 | Average Yield | In-house | m²/kg | 2.96 | 2.90 | |
| | Opaque | | | | | |
| 6 | Tensile Strength | ASTM | Kg/cm² | | | |
| | Longitudinal | D882 | | 457.92 | 400 | min |
| | Transverse | | | 540.92 | 400 | min |
| 7 | Peak Elongation | ASTM | % | | | |
| | Longitudinal | D882 | | 3.62 | 4 | Min |
| | Transverse | | | 3.79 | 4 | Min |
| 8 | Dimensional | ASTM | % | | | |
| | Stability | D1204 | | | | |
| | Longitudinal | | | −7 | −7 | max |
| | Transverse | | | +2 | +2 | max |
| 9 | Heat Seal | In-house | Kgf/cm | 0.80 | 0.30 | min |
| | Strength (PVC to | | | | | |
| | Al. foil) | | | | | |

The Physical and thermo mechanical properties of the bio-degradable PVC film prepared in accordance with the process of the present disclosure are at par with the non-degradable 250 microns PVC film. 2. Blister forming machine trials

Thermoforming trials were taken on rotary vacuum forming as well flat pressure forming thermoforming machines with various cavity sizes and found that it perform exactly same as the regular thermoforming PVC films. The thermoforming parameters remain same with that of regular films.

| | | | | 250 | Thermoforming |
|---|---|---|---|---|---|
| | | | | Micron Bio- | temperature of |
| | | | | PVC film as | General Bilcare |
| Sr. | | Test | | prepared in | 250 Micron |
| No | Parameters | Method | Unit | Example II | PVC film |
| 1 | Thermo | In-house | ° C. | 150-155° C. | 150-155 C. |
| | formability in | | | | |
| | rotary vacuum | | | | |
| | forming machine | | | | |
| | at 20-25 Inches of | | | | |
| | vacuum | | | | |
| 2 | Thermformability | In-house | ° C. | 105-120° C. | 105-120° C. |
| | in flat bed | | | | |
| | pressure forming | | | | |
| | machine at | | | | |
| | 5-6 Kg pressure | | | | |

Thermo formability of the bio-degradable PVC film prepared in accordance with the process of the present disclosure is at par with the non-degradable 250 microns PVC film.

3. Biodegradability Tests:

Determining anaerobic biodegradation of plastic materials under high solids anaerobic digestion conditions

Inoculum Source:
Organic Compost—McEnroe Organic Farms, Millerton, N.Y. Mattabassit Waste Treatment Facility Anaerobic Digestion

| | |
|---|---|
| Solid Content | 22% |
| pH | 8.2 |
| Volatile Fatty Acids | 0.7 g/kg |
| Ammonia Nitrogen | 1.0 mg/kg |
| Volatile Solids | 24.9% |

Procedure: The procedure followed was the same as described in Example I

### Theoretical Gas Production

| | Carbon | | |
|---|---|---|---|
| | Content | Methane | Carbon Dioxide |
| Samples | (grams) | (grams) | (grams) |
| 250 Micron Bio-PVC film as | 9.61 | 12.9 | 35.2 |
| prepared in Example II | | | |
| Negative Control | 21.4 | 28.6 | 78.5 |
| (PE) (25 grams) | | | |
| Positive Control | 8.8 | 11.8 | 32.3 |
| (Cellulose) (20 grams) | | | |

### Gas Production Data—Samples

| | 250 Micron Bio- | | | | | | | | | | | |
|---|---|---|---|---|---|---|---|---|---|---|---|---|
| | PVC film as | | | | | | | | | | | |
| | prepared in | | | Negative Control | | | Positive Control | | | | | |
| | Example II | | | PE | | | Cellulose | | | Inoculum Control | | |
| Day | A | B | C | A | B | C | A | B | C | A | B | C |
| Totals | 4992 | 5012 | 5153 | 1657 | 1298 | 1296 | 19334 | 19621 | 20238 | 2597 | 2283 | 2142 |
| 1-30 | | | | | | | | | | | | |
| Totals | 738 | 621 | 562 | 309 | 311 | 271 | 1030 | 954 | 1137 | 420 | 313 | 366 |
| 31-45 | | | | | | | | | | | | |
| Avgs | 640 | | | 297 | | | 1040 | | | 366 | | |
| 31-45 | | | | | | | | | | | | |

### Methane and Carbon Dioxide Readings

| | 250 Micron Bio- | | | | | | | |
|---|---|---|---|---|---|---|---|---|
| | PVC film as | | Negative | | Positive | | | |
| | prepared in | | Control | | Control | | Inoculum | |
| | Example II | | PE | | Cellulose | | Control | |
| | | | | Car- | | Car- | | Car- |
| | | | | bon | | bon | | bon |
| Day | Meth- | Carbon | Meth- | Di- | Meth- | Di- | Meth- | Di- |
| % | ane | Dioxide | ane | oxide | ane | oxide | ane | oxide |
| 33 | 16% | 13.8% | 12% | 7.6% | 29% | 25.9% | 13% | 9.3% |
| 38 | 21% | 12.9% | 9% | 7.3% | 32% | 29.7% | 10% | 7.6% |
| 42 | 13% | 10.2% | 8% | 7.9% | 26% | 24.2% | 9% | 9.1% |
| Avg | 16.7% | 12.3% | 9.7% | 7.6% | 29% | 26.6% | 10.7% | 8.7% |

### Calculations of Results

| | | Average | Methane | | | Carbon Dioxide | | | | |
|---|---|---|---|---|---|---|---|---|---|---|
| | Average | Gas | | | (Wt) | | | (Wt) | Total | |
| | Weight | Vol. | | | C | | | C | CH4+ | Sample- |
| Sample | grams | (mL) | (%) | (mL) | (grams) | (%) | (mL) | (grams) | CO2 | Inoculum= |
| 250 Micron | 25 | 640 | 16.7 | 107 | 0.057 | 12.3 | 79 | 0.042 | 0.099 | 0.061 |
| Bio-PVC film | | | | | | | | | | |
| as prepared | | | | | | | | | | |
| in Example II | | | | | | | | | | |
| Negative | 25 | 297 | 9.7 | 29 | 0.016 | 7.6 | 23 | 0.012 | 0.028 | 0 |
| Control | | | | | | | | | | |
| PE | | | | | | | | | | |
| Positive | 20 | 1040 | 29 | 302 | 0.16 | 26.7 | 278 | 0.15 | 0.31 | 0.272 |
| Control | | | | | | | | | | |
| Inoculum | 1000 | 366 | 10.7 | 39 | 0.021 | 8.7 | 32 | 0.017 | 0.038 | |
| Control | | | | | | | | | | |

Results (Average of 3)

| | Gaseous | | (%) | (%) |
|---|---|---|---|---|
| | Carbon | Theoretical | Biodegradation | Biodegradation |
| | Recovered | Grams | Days 31-45 | Days 1-45 |
| 250 | 0.06 | 9.61 | 0.065% | 8.015% |
| Micron | | | | |
| Bio-PVC | | | | |
| film as | | | | |
| prepared | | | | |
| in | | | | |
| Example II | | | | |
| Negative | 0 | 21.4 | 0% | 0% |
| Control | | | | |
| PE | | | | |
| Positive | 0.272 | 8.8 | 3.09% | 91.09% |
| Control | | | | |

The results support the suitability of the product for the blister packing application. It also depicts the biodegradation of the film.

### Example III

### Preparation of Biodegradable and Compostable and Stretched PVC Film of 250 Micron

A. Batch Mixing Operation:

187.00 kg of PVC homopolymer suspension resin, 243.00 kg of Vinyl chloride/Vinyl Acetate copolymer, 34.100 kg of Methylmethacrylate-Butadiene-Styrene acrylic copolymer, 6.330 kg of Polymer stabilizer, 21.900 kg of Dicarboxylic acid ester, 1.460 kg of Fatty acid ester of polyfunctional alcohols, 1.220 kg of butadiene/methylmethacrylate/styrene processing aid, 0.487 kg of Montanic ester wax, 0.414 kg of Mg-Silicate based talc and 3.410 kg of Bio Pro-degradent (Eco-pure™ manufactured by Bio-tech Environmental, LLC) were added to the batch mixing system from the respective storage system using programmable logic controlled material dosage/discharge systems and mixed to obtain a thoroughly mixed batch of ingredients.

B. Calender Operation:

The following process protocol was followed for carrying out the calendering operation.

| PROCESS | EQUIP- | | | |
|---|---|---|---|---|
| STEP | MENT | PARAMETER | UNIT | VALUE |
| Extruder | Ko- | Difference | % | 12.09 |
| | Kneader | between the | | |
| | | torque of the | | |
| | | feeder screw | | |
| | | and the torque of | | |
| | | the output screw | | |
| | | Screw speed | rpm | 9.4 |

| | | | | |
|---|---|---|---|---|
| Calendering | Temperature | Cylinder 1 | ° C. | 159 |
| | Speed | | m/min | 14.6 |
| | Temperature | Cylinder 2 | ° C. | 160 |
| | Speed | | m/min | 16.1 |
| | Temperature | Cylinder 3 | ° C. | 174 |
| | Speed | | m/min | 17.8 |
| | Temperature | Cylinder 4 | ° C. | 193 |
| | Speed | | m/min | 20.7 |
| | Temperature | Cylinder 5 | ° C. | 162 |
| | Speed | | | 25.2 |
| Winder | Web tension | | (dN) | 250 |

The film was prepared by the process as described in Example I.

C. Test Data

The Bio degradable film thus produced is tested for Biodegradability properties to prove its application for blister packing application.

### Results:

1. Biodegradability tests:

Determining anaerobic biodegradation of plastic materials under high solids anaerobic digestion conditions

Inoculum Source:
Organic Compost—McEnroe Organic Farms, Millerton, N.Y. Mattabassit Waste Treatment Facility Anaerobic Digestion

| | |
|---|---|
| Solid Content | 22% |
| pH | 8.2 |
| Volatile Fatty Acids | 0.7 g/kg |
| Ammonia Nitrogen | 1.0 mg/kg |
| Volatile Solids | 24.9% |

Procedure: The procedure followed was the same as described in Example I

### Theoretical Gas Production

| | Carbon | | |
|---|---|---|---|
| | Content | Methane | Carbon Dioxide |
| Samples | (grams) | (grams) | (grams) |
| 250 Micron Bio-PVC film as | 9.61 | 12.9 | 35.2 |
| prepared in Example III | | | |
| Negative Control | 21.4 | 28.6 | 78.5 |
| (PE) (25 grams) | | | |
| Positive Control | 8.8 | 11.8 | 32.3 |
| (Cellulose) (20 grams) | | | |

### Gas Production Data—Samples

| | 250 Micron Bio- | | | | | | | | | | | |
|---|---|---|---|---|---|---|---|---|---|---|---|---|
| | PVC film as | | | | | | | | | | | |
| | prepared in | | | | | | | | | | | |
| | Example III | | | 9.61 | | | 12.9 | | | 35.2 | | |
| Day | A | B110 | 258C | A | B | C | A | B | C | A | B | C |
| Totals | 4752 | 5203 | 4344 | 1657 | 1298 | 1296 | 19334 | 19621 | 20238 | 2557 | 2283 | 2142 |
| 1-30 | | | | | | | | | | | | |
| Totals | 748 | 716 | 800 | 311 | 271 | 1030 | 1030 | 954 | 1137 | 420 | 313 | 366 |
| 31-45 | | | | | | | | | | | | |
| Avgs | 1085 | | | 297 | | | 1040 | | | 366 | | |
| 31-45 | | | | | | | | | | | | |

### Methane and Carbon Dioxide Readings

| | 250 Micron Bio- | | | | | | | |
|---|---|---|---|---|---|---|---|---|
| | PVC film as | | | | | | | |
| | prepared in | | | | | | | |
| | Example III | | 9.61 | | 12.9 | | 35.2 | |
| | | Car- | | Car- | | Car- | | Car- |
| | | bon | | bon | | bon | | bon |
| Day | Meth- | Di- | Meth- | Di- | Meth- | Di- | Meth- | Di- |
| % | ane | oxide | ane | oxide | ane | oxide | ane | oxide |
| 33 | 15% | 13.8% | 12% | 7.6% | 29% | 25.9% | 13% | 9.3% |
| 38 | 15% | 10.9% | 9% | 7.3% | 26% | 24.2% | 10% | 7.6% |
| 42 | 19% | 12.1% | 8% | 7.9% | 26% | 24.2% | 9% | 9.1% |
| Avg | 16.3% | 12.3% | 9.7% | 7.6% | 29% | 26.6% | 10.7% | 8.7% |

### Calculations of Results

| | | Average | Methane | | | Carbon Dioxide | | | | |
|---|---|---|---|---|---|---|---|---|---|---|
| | Average | Gas | | | (Wt) | | | (Wt) | | |
| | Weight | Vol. | | | C | | | C | Total | Sample- |
| Sample: | grams | (mL) | (%) | (mL) | (grams) | (%) | (mL) | (grams) CO2 | CH4+ | Inoculum= |
| 250 Micron | 25 | 755 | 16.3 | 123 | 0.066 | 12.3 | 93 | 0.05 | 0.116 | 0.078 |
| Bio-PVC film | | | | | | | | | | |
| as prepared | | | | | | | | | | |
| in Example III | | | | | | | | | | |
| Negative | 25 | 297 | 9.7 | 29 | 0.016 | 7.6 | 23 | 0.012 | 0.028 | 0 |
| Control | | | | | | | | | | |
| PE | | | | | | | | | | |
| Positive | 20 | 1040 | 29 | 302 | 0.16 | 26.7 | 278 | 0.15 | 0.31 | 0.272 |
| Control | | | | | | | | | | |
| Inoculum | 1000 | 366 | 107 | 39 | 0.028 | 8.7 | 32 | 0.017 | 0.038 | |
| Control | | | | | | | | | | |

Results (Average of 3)

| | Gaseous | | (%) | (%) |
|---|---|---|---|---|
| | Carbon | Theoretical | Biodegradation | Biodegradation |
| | Recovered | Grams | Days 31-45 | Days 1-45 |
| 250 Micron | 0.078 | 9.61 | 0.81 | 7.2 |
| Bio-PVC | | | | |
| film as | | | | |
| prepared in | | | | |
| Example III | | | | |
| Negative | 0 | 21.4 | 0 | 0 |
| Control | | | | |
| PE | | | | |
| Positive | 0.272 | 8.8 | 3.09 | 91.09 |
| Control | | | | |

The results support the suitability of the product for the blister packing application. It also depicts the biodegradation of the film prepared in accordance with the process of the present disclosure.

### Example IV

### A. Batch Mixing Operation

187.00 kg of PVC homopolymer suspension resin, 243.00 kg of Vinyl chloride/Vinyl Acetate copolymer, 34.100 kg of Methylmethacrylate-Butadiene-Styrene acrylic copolymer, 6.330 kg of Polymer stabilizer, 21.900 kg of Dicarboxylic acid ester, 1.460 kg of Fatty acid ester of polyfunctional alcohols, 1.220 kg of butadiene/methylmethacrylate/styrene processing aid, 0.487 kg of Montanic ester wax, 0.414 kg of Mg-Silicate based talc and 3.410 kg of Bio Pro-degradent (Eco-pure™ manufactured by Bio-tech Environmental, LLC) were added to the batch mixing system from the respective storage system using programmable logic controlled material dosage/discharge systems and mixed to obtain a thoroughly mixed batch of ingredients.

### B. Calender Operation

The following process protocol as developed by the inventors of the present disclosure was followed for carrying out the calendering operation.

The same manufacturing process as in the example 1 is followed till the calendering stage. Further the film is heated and stretched in both directions to make it a thinner film. These films are used for shrink packaging applications.

| PROCESS | EQUIP- | | | |
|---|---|---|---|---|
| STEP | MENT | PARAMETER | UNIT | VALUE |
| Extruder | Ko- | Difference | % | 12.09 |
| | Kneader | between the | | |
| | | torque of the | | |
| | | feeder screw | | |
| | | and the torque of | | |
| | | the output screw | | |
| | | Screw speed | rpm | 9.4 |

| | | | | |
|---|---|---|---|---|
| Calendering | Temperature | Cylinder 1 | ° C. | 159 |
| | Speed | | m/min | 14.6 |
| | Temperature | Cylinder 2 | ° C. | 160 |
| | Speed | | m/min | 16.1 |
| | Temperature | Cylinder 3 | ° C. | 174 |
| | Speed | | m/min | 17.8 |
| | Temperature | Cylinder 4 | ° C. | 193 |
| | Speed | | m/min | 20.7 |
| | Temperature | Cylinder 5 | ° C. | 162 |
| | Speed | | m/min | 25.2 |
| Winder | Web tension | | (dN) | 250 |
| Stenter | Temperature | Heat Zone 1 | ° C. | 105 |
| | | Heat | ° C. | 95 |
| | | Zone 2 | | |
| | | Heat Zone 3 | ° C. | 90 |
| | | Stretch | ° C. | 88 |
| | | Zone1 | | |
| | | Stretch | ° C. | 88 |
| | | Zone 2 | | |

### C. Test Data

The film thus produced is tested for its biodegradability

### Results:

Determining anaerobic biodegradation of plastic materials under high solids anaerobic digestion conditions

### Inoculum Source:

Organic Compost—McEnroe Organic Farms, Millerton, N.Y. Mattabassit Waste Treatment Facility Anaerobic Digestion

| | |
|---|---|
| Solid Content | 22% |
| pH | 8.2 |
| Volatile Fatty Acids | 0.7 g/kg |
| Ammonia Nitrogen | 1.0 mg/kg |
| Volatile Solids | 24.9% |

Procedure: The procedure followed was the same as described in Example I

The results are shown in the following tables.

### Theoretical Gas Production

| | Carbon | | Carbon |
|---|---|---|---|
| | Content | Methane | Dioxide |
| Samples | (grams) | (grams) | (grams) |
| Bio-PVC film as prepared in Example IV | 9.61 | 12.9 | 35.2 |
| Negative Control | 21.4 | 28.6 | 78.5 |
| (PE) (25 grams) | | | |
| Positive Control | 8.8 | 11.8 | 32.3 |
| (Cellulose) (20 grams) | | | |

### Gas Production Data—Samples

| | Bio-PVC film as | | | | | | | | | | | |
|---|---|---|---|---|---|---|---|---|---|---|---|---|
| | prepared in | | | Negative Control | | | Positive Control | | | | | |
| | Example IV | | | PE | | | Cellulose | | | Inoculum Control | | |
| Day | A | B | C | A | B | C | A | B | C | A | B | C |
| Totals | 5819 | 5683 | 4572 | 1710 | 971 | 1019 | 17457 | 18409 | 16671 | 1686 | 1550 | 1650 |
| 1-30 | | | | | | | | | | | | |
| 31 | 75 | 83 | 73 | 9 | 22 | 24 | 66 | 97 | 107 | 9 | 12 | 12 |
| 32 | 75 | 83 | 73 | 9 | 22 | 24 | 66 | 97 | 107 | 9 | 12 | 12 |
| 33 | 75 | 83 | 73 | 9 | 22 | 24 | 66 | 97 | 107 | 9 | 12 | 12 |
| 34 | 75 | 50 | 95 | 25 | 30 | 25 | 325 | 250 | 245 | 60 | 50 | 50 |
| 35 | 75 | 50 | 95 | 25 | 30 | 25 | 325 | 250 | 245 | 60 | 50 | 50 |
| 36 | 89 | 71 | 84 | 9 | 19 | 7 | 173 | 138 | 148 | 37 | 24 | 17 |
| 37 | 89 | 71 | 84 | 9 | 19 | 7 | 173 | 138 | 148 | 37 | 24 | 17 |
| 38 | 89 | 71 | 84 | 9 | 19 | 7 | 173 | 138 | 148 | 37 | 24 | 17 |
| 39 | 89 | 71 | 84 | 9 | 19 | 7 | 173 | 138 | 148 | 37 | 24 | 17 |
| 40 | 91 | 98 | 98 | 7 | 35 | 28 | 278 | 165 | 116 | 35 | 28 | 70 |
| 41 | 91 | 98 | 98 | 7 | 35 | 28 | 278 | 165 | 116 | 35 | 28 | 70 |
| 42 | 91 | 98 | 98 | 7 | 35 | 28 | 278 | 165 | 116 | 35 | 28 | 70 |
| 43 | 21 | 39 | 35 | 19 | 11 | 21 | 55 | 39 | 49 | 23 | 19 | 9 |
| 44 | 21 | 39 | 35 | 19 | 11 | 21 | 55 | 39 | 49 | 23 | 19 | 9 |
| 45 | 21 | 39 | 35 | 19 | 11 | 21 | 55 | 39 | 49 | 23 | 19 | 9 |
| Totals | 1067 | 1044 | 1144 | 191 | 340 | 297 | 2539 | 1955 | 1898 | 469 | 373 | 441 |
| 31-45 | | | | | | | | | | | | |
| Avgs | 1085 | | | 276 | | | 2131 | | | 428 | | |
| 31-45 | | | | | | | | | | | | |

### Methane and Carbon Dioxide Readings

| | Bio-PVC film | | Negative | | Positive | | | |
|---|---|---|---|---|---|---|---|---|
| | as prepared in | | Control | | Control | | Inoculum | |
| | Example IV | | PE | | Cellulose | | Control | |
| | | Car- | | Car- | | Car- | | Car- |
| | | bon | | bon | | bon | | bon |
| Day | Meth- | Di- | Meth- | Di- | Meth- | Di- | Meth- | Di- |
| % | ane | oxide | ane | oxide | ane | oxide | ane | oxide |
| 35 | 20% | 19.3% | 9% | 8.1% | 21% | 17.6% | 7% | 4.8% |
| 40 | 21% | 17.4% | 7% | 5.4% | 25% | 14.5% | 5% | 4.5% |
| 45 | 17% | 15.6% | 4% | 3.9% | 12% | 9.1% | 5% | 4.5% |
| Avg | 19.3% | 17.4% | 6.7% | 5.8% | 19.3% | 13.7% | 5.7% | 4.6% |

### Calculations of Results

| | | Average | Methane | | | Carbon Dioxide | | | | |
|---|---|---|---|---|---|---|---|---|---|---|
| | Average | Gas | | | (Wt) | | | (Wt) | Total | |
| | Weight | Vol. | | | C | | | C | CH4 + | Sample- |
| Sample | grams | (mL) | (%) | (mL) | (grams) | (%) | (mL) | (grams) | CO2 | Inoculum= |
| Bio-PVC film | 25 | 1085 | 19.3 | 209 | 0.11 | 17.4 | 189 | 0.1 | 0.21 | 0.19 |
| as prepared | | | | | | | | | | |
| in Example IV | | | | | | | | | | |
| Negative | 25 | 276 | 6.7 | 19 | 0.01 | 5.8 | 16 | 0.009 | 0.019 | 0 |
| Control | | | | | | | | | | |
| PE | | | | | | | | | | |
| Positive | 20 | 2131 | 19.3 | 411 | 0.22 | 13.7 | 292 | 0.16 | 0.38 | 0.36 |
| Control | | | | | | | | | | |
| Inoculum | 1000 | 428 | 5.7 | 24 | 0.01 | 4.6 | 20 | 0.01 | 0.02 | |
| Control | | | | | | | | | | |

Results (Average of 3)

| | Gaseous | | (%) | (%) |
|---|---|---|---|---|
| | Carbon | Theoretical | Biodegradation | Biodegradation |
| | Recovered | Grams | Days 31-45 | Days 1-45 |
| Bio-PVC | 0.19 | 9.61 | 1.98% | 9.57% |
| film as | | | | |
| prepared in | | | | |
| Example IV | | | | |
| Negative | 0 | 21.4 | 0% | 0% |
| Control | | | | |
| PE | | | | |
| Positive | 0.36 | 8.8 | 4.09% | 87.39% |
| Control | | | | |

The results support the suitability of the product for the blister packing application. It also depicts the biodegradation of the film prepared in accordance with the process of the present disclosure.

### Example V

### A. Batch Mixing Operation

407.00 kg of PVC homopolymer suspension resin, 24.700 kg of Vinyl chloride/vinyl Acetate Copolymer, 6.900 kg of Polymer stabilizer, 37.00 kg of Acrylic polymer impact modifier, 1.480 kg of Montanic ester wax, 6.160 kg of epoxidized soyabean oil, 6.160 kg of Partial esters of fatty acids with glycerol, 2.460 kg of butadiene/methylmethacrylate/styrene processing aid, 1.230 kg of Bis-stearoyl-ethylenediamine, 1.230 kg of PolyVinyl chloride, 1.230 kg of Acrylic polymer processing aid, 0.988 kg of Polyadipate, 0.367 kg of Mg-Silicate based talc and 3.480 kg of Bio Pro-degradent (Eco-pure™ manufactured by Bio-tech Environmental, LLC) were added to the batch mixing system from the respective storage system using programmable logic controlled material dosage/discharge systems and mixed to obtain a thoroughly mixed batch of ingredients.

### B. Calender Operation

The following process protocol was followed for carrying out the calendering operation.

| PROCESS | EQUIP- | | | |
|---|---|---|---|---|
| STEP | MENT | PARAMETER | UNIT | VALUE |
| Extruder | Ko- | Difference | % | 11.54 |
| | | Kneader between | | |
| | | the torque of the | | |
| | | feeder screw | | |
| | | and the torque of | | |
| | | the output screw | | |
| | | Screw speed | rpm | 8.5 |

| | | | | |
|---|---|---|---|---|
| Calendering | Temperature | Cylinder 1 | ° C. | 175 |
| | Speed | | m/min | 13.7 |
| | Temperature | Cylinder 2 | ° C. | 177 |
| | Speed | | m/min | 15.1 |
| | Temperature | Cylinder 3 | ° C. | 190 |
| | Speed | | m/min | 16.6 |
| | Temperature | Cylinder 4 | ° C. | 205 |
| | Speed | | m/min | 19.5 |
| | Temperature | Cylinder 5 | ° C. | 175 |
| | Speed | | m/min | 24.8 |
| Winder | Web tension | | (dN) | 250 |
| Stenter | Temperature | Heat Zone 1 | ° C. | 115 |
| | | Heat | ° C. | 102 |
| | | Zone 2 | | |
| | | Heat Zone 3 | ° C. | 100 |
| | | Stretch | ° C. | 99 |
| | | Zone1 | | |
| | | Stretch | ° C. | 98 |
| | | Zone 2 | | |

The same manufacturing process as in the example 1 is followed till the calendering stage. Further the film is heated and stretched in both directions to make it a thinner film. These films are used for shrink packaging applications.

### C. Test Data

The film thus produced is tested for its biodegradability

### Results:

Determining anaerobic biodegradation of plastic materials under high solids anaerobic digestion conditions

### Inoculum Source:

Organic Compost—McEnroe Organic Farms, Millerton, N.Y. Mattabassit Waste Treatment Facility Anaerobic Digestion

| | |
|---|---|
| Solid Content | 22% |
| pH | 8.2 |
| Volatile Fatty Acids | 0.7 g/kg |
| Ammonia Nitrogen | 1.0 mg/kg |
| Volatile Solids | 24.9% |

Procedure: The procedure followed was the same as described in Example I

The results are shown in the following tables.

### Theoretical Gas Production

| | Carbon | | Carbon |
|---|---|---|---|
| | Content | Methane | Dioxide |
| Samples | (grams) | (grams) | (grams) |
| Bio-PVC film as prepared in Example V | 9.61 | 12.9 | 35.2 |
| Negative Control | 21.4 | 28.6 | 78.5 |
| (PE) (25 grams) | | | |
| Positive Control | 8.8 | 11.8 | 32.3 |
| (Cellulose) (20 grams) | | | |

### Gas Production Data—Samples

| | Bio-PVC film as | | | | | | | | | | | |
|---|---|---|---|---|---|---|---|---|---|---|---|---|
| | prepared in | | | Negative Control | | | Positive Control | | | | | |
| | Example V | | | PE | | | Cellulose | | | Inoculum Control | | |
| Day | A | B | C | A | B | C | A | B | C | A | B | C |
| Totals | 5267 | 4823 | 4635 | 1525 | 2063 | 1664 | 17525 | 18001 | 15342 | 3140 | 2805 | 2711 |
| 1-30 | | | | | | | | | | | | |
| Totals | 901 | 1100 | 852 | 247 | 220 | 215 | 1198 | 1377 | 1441 | 300 | 266 | 319 |
| 31-45 | | | | | | | | | | | | |
| Avgs | 951 | | | 227 | | | 1339 | | | 295 | | |
| 31-45 | | | | | | | | | | | | |

### Methane and Carbon Dioxide Readings

| | Bio-PVC film | | Negative | | Positive | | | |
|---|---|---|---|---|---|---|---|---|
| | as prepared in | | Control | | Control | | Inoculum | |
| | Example V | | PE | | Cellulose | | Control | |
| | | Car- | | Car- | | Car- | | Car- |
| | | bon | | bon | | bon | | bon |
| Day | Meth- | Di- | Meth- | Di- | Meth- | Di- | Meth- | Di- |
| % | ane | oxide | ane | oxide | ane | oxide | ane | oxide |
| 34 | 18% | 19.9% | 5% | 3.8% | 29% | 26.8% | 7% | 5.4% |
| 38 | 16% | 15.9% | 3% | 3.5% | 30% | 29.2% | 3% | 2.9% |
| 45 | 16% | 15.9% | 3% | 3.5% | 27% | 24.3% | 4% | 3.4% |
| Avg | 16.7% | 17% | 3.7% | 3.5% | 28.7% | 26.8% | 4.7% | 3.9% |

### Calculations of Results

| | | Average | Methane | | | Carbon Dioxide | | | | |
|---|---|---|---|---|---|---|---|---|---|---|
| | Average | Gas | | | (Wt) | | | (Wt) | Total | |
| | Weight | Vol. | | | C | | | C | CH4 + | Sample- |
| Sample | grams | (mL) | (%) | (mL) | (grams) | (%) | (mL) | (grams) | CO2 | Inoculum= |
| Bio-PVC film | 25 | 951 | 16.7 | 159 | 0.09 | 17 | 162 | 0.09 | 0.18 | 0.17 |
| as prepared | | | | | | | | | | |
| in Example V | | | | | | | | | | |
| Negative | 25 | 227 | 3.7 | 8 | 0.004 | 3.5 | 8 | 0.004 | 0.008 | 0 |
| Control | | | | | | | | | | |
| PE | | | | | | | | | | |
| Positive | 20 | 1339 | 28.7 | 384 | 0.21 | 26.8 | 359 | 0.19 | 0.40 | 0.39 |
| Control | | | | | | | | | | |
| Inoculum | 1000 | 295 | 4.7 | 14 | 0.008 | 3.9 | 12 | 0.006 | 0.004 | |
| Control | | | | | | | | | | |

Results (Average of 3)

| | Gaseous | | (%) | (%) |
|---|---|---|---|---|
| | Carbon | Theoretical | Biodegradation | Biodegradation |
| | Recovered | Grams | Days 31-45 | Days 1-45 |
| Bio-PVC | 0.17 | 9.61 | 1.77% | 10.1% |
| film as | | | | |
| prepared in | | | | |
| Example V | | | | |
| Negative | 0 | 21.4 | 0% | 0% |
| Control | | | | |
| PE | | | | |
| Positive | 0.39 | 8.8 | 4.43% | 84.65% |
| Control | | | | |

The results support the suitability of the product for the blister packing application. It also depicts the biodegradation of the film prepared in accordance with the process of the present disclosure.

### Example VI

The film produced as per the example I is kept at temperature and Humidity conditions of 40° C. and 75% RH for testing the possibility of any microbial growth or yield or mould growth due to the biodegradability characteristics of the film for testing its applicability in food and pharma contact materials.

### Testing Procedure

1. Sampling Locations
The films produced as per example 1 were kept at environmental chamber maintaining 40° C. and 75% RH. Films were periodically withdrawn from the chambers and tested for any microbial, mould or yield growth. In Parallel, a non bio-degradable sample was also studied under the same condition as the reference sample.

2. Sampling & Analysis methodology
a) Total plate count and Total yeast & mould cound (Swab Sample)

Sampling Technique
A Sterile Swab was being moistened in the swab head. Rub the swab head slowly and thoroughly over approximately 100 cm² (with a 10×10 cm sterile template) of surface three times, reversing direction between strokes.

Pour Plate Technique
For total bacterial count: Pipette 1 ml of liquid from the phosphate buffer solution in to a sterile petri dish. Add sterile Trypticase Soy Agar (TSA) into the inoculated dish, rotate and allowed to solidify and was then incubated or 48 hours at 35° C. For Total yeast & mould count add sterile Potato Dextrose Agar (PDA) into the inoculated dish and was then incubated for 120 hours at 25° C.
   Results are tabulated in Table 1.

TABLE 1
Comparative microbial test results of 250 Micron Bio-PVC White Opaque
film prepared in example 1 and 300 Micron PVC Glass Clear, Bilcare

| | | Number of | Total Bacterial | Total Yeast & |
|---|---|---|---|---|
| Sr | | Months | Counts | Mould Counts |
| No. | Product | (Mths) | (CFC/100 cm²) | (CFC/100 cm²) |
| 1 | 250 Mics bio- | 1 | <10 | <10 |
| | PVC White | | | |
| | Opaque as | | | |
| | prepared in | | | |
| | example 1 | | | |
| 2 | 300 Mics PVC | 1 | <10 | <10 |
| | Glass Clear | | | |
| 3 | 250 Mics bio- | 2 | <10 | <10 |
| | PVC White | | | |
| | Opaque as | | | |
| | prepared in | | | |
| | example 1 | | | |
| 4 | 300 Mics PVC | 2 | <10 | <10 |
| | Glass Clear | | | |
| 5 | 250 Mics bio- | 3 | <10 | <10 |
| | PVC White | | | |
| | Opaque as | | | |
| | prepared in | | | |
| | example 1 | | | |
| 6 | 300 Mics PVC | 3 | <10 | <10 |
| | Glass Clear | | | |
| 7 | 250 Mics bio- | 4 | <10 | <10 |
| | PVC White | | | |
| | Opaque as | | | |
| | prepared in | | | |
| | example 1 | | | |
| 8 | 300 Mics PVC | 4 | <10 | <10 |
| | Glass Clear | | | |
| 9 | 250 Mics bio- | 5 | <10 | <10 |
| | PVC White | | | |
| | Opaque as | | | |
| | prepared in | | | |
| | example 1 | | | |
| 10 | 300 Mics PVC | 5 | <10 | <10 |
| | Glass Clear | | | |
| 11 | 250 Mics bio- | 6 | <10 | <10 |
| | PVC White | | | |
| | Opaque as | | | |
| | prepared in | | | |
| | example 1 | | | |
| 12 | 300 Mics PVC | 6 | <10 | <10 |
| | Glass Clear | | | |

Form the test results it is seen that the Bacterial and Yeast & Mould counts were not detected in both the biodegradable film as well as the reference film. This proves that the invented film is biodegradable only at land filling, anaerobic conditions and no microbial growth is possible at the regular storage condition. This makes the film suitable for the food and drug contact application though it is capable of biodegradation after use.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “a”, “at least” or “at least one” suggests the use of one or more elements or ingredients or quantities, as the use may be in the embodiment of the disclosure to achieve one or more of the desired objects or results.

The numerical values given for various physical parameters, dimensions and quantities are only approximate values and it is envisaged that the values higher or lower than the numerical value assigned to the physical parameters, dimensions and quantities fall within the scope of the disclosure and the claims unless there is a statement in the specification to the contrary.

As used in the present disclosure, the following words and phrases are generally intended to have the meanings as set forth below, except to the extent that the context in which they are used to indicate otherwise.

The expression “pharmaceutical grade PVC” as used in the present disclosure, means a PVC material wherein the Vinyl Chloride Monomer content in said material is below 1 PPM, non-toxic and complies to regulatory requirements for food and drug contact applications.

While certain embodiments of the inventions have been described, these embodiments have been presented by way of examples only, and are not intended to limit the scope of the disclosure. Variations or modifications in the combination of this invention, within the scope of the disclosure, may occur to those skilled in the art upon reviewing the disclosure herein. Such variations or modifications are well within the spirit of this disclosure. The accompanying claims and their equivalents are intended to cover such forms or modifications as would fall within the scope and spirit of the disclosure.

What is claimed is:

1. A process for preparing a bio-degradable PVC based pharmaceutical grade thermo-formable film, said process comprising the following steps:
a. mixing pharmaceutical grade PVC resin, copolymer, at least one impact modifier, bio pro-degradent, at least one processing aid, and at least one stabilizer in a mixer to obtain a mixed batch of ingredients;
b. extruding the mixed batch of ingredients in an extruder at a screw speed ranging between 2 rpm and 15 rpm and temperature ranging between 55° C. and 70° C. to obtain fluxed polymeric flakes; and
c. calendering the polymeric flakes by subjecting them to at least two calender rolls maintained at temperatures ranging between 100° C. and 250° C. to obtain a bio-degradable PVC based pharmaceutical grade thermo-formable film,
wherein, said film is stable in aerobic conditions and is bio-degradable under anaerobic conditions.

2. The process as claimed in claim 1, wherein the method step of mixing further comprises adding at least one pigment in the mixed batch.

3. The process as claimed in claim 1, wherein the method step of mixing further comprises adding titanium dioxide in the mixed batch.

4. The process as claimed in claim 1, wherein the method step of extruding comprises maintaining a predetermined percentage difference between the torque of the feeder screw and torque of the output screw of the extruder which causes generation of pressure and heat on the mixture, resulting in fluxing of the material.

5. The process as claimed in claim 4, wherein the percentage difference between the torque of the feeder screw and torque of the output screw ranges between 5 and 20, preferably, 8 and 16.

6. The process as claimed in claim 1, wherein the pharmaceutical grade PVC resin is at least one selected from the group consisting of PVC suspension resin and PVC homopolymer suspension resin.

7. The process as claimed in claim 1, wherein the copolymer is Vinyl Chloride/Vinyl Acetate copolymer.

8. The process as claimed in claim 1, wherein the impact modifier is at least one selected from the group consisting of methylmethacrylate-butadiene-styrene-acrylic copolymer and acrylic modifier.

9. The process as claimed in claim 1, wherein the amount of bio pro-degradent ranges between 0.01% and 20% with respect to the mass of the film, preferably, 0.1% and 10.0% with respect to the mass of the film; and the bio pro-degradent is Ethylene-Vinyl Acetate copolymer with organoleptic additives.

10. The process as claimed in claim 1, wherein the processing aid is at least one selected from the group consisting of anti-blocking/slipping agents, antistatic agents, lubricants, release agents, anti-sticking agents and melt strength/viscosity balancing agents; and the stabilizer is at least one selected from the group consisting of polymer and soyabean stabilizer.

11. The process as claimed in claim 1, wherein the two calender rolls are arranged at a distance ranging between 0.01 mm and 50 mm from each other.

12. The process as claimed in claim 1, wherein the calender rolls are arranged in a cross-axial or bending position.

13. A bio-degradable PVC based pharmaceutical grade thermo-formable film obtained by a process of claim 1, said film comprising:
i. a pharmaceutically grade PVC resin, ii. a copolymer, iii. at least one impact modifier, iv. A bio pro-degradent, v. at least one processing aid, vi. optionally, a titanium dioxide, vii. at least one stabilizer and viii optionally, at least one pigment,
wherein, said film is stable in aerobic conditions and is bio-degradable under anaerobic conditions,
wherein the pharmaceutical grade PVC resin is at least one selected from the group consisting of PVC suspension resin and PVC homopolymer suspension resin, wherein the copolymer is Vinyl Chloride/Vinyl Acetate copolymer,
wherein the impact modifier is at least one selected from the group consisting of methylmethacrylate-butadiene-styrene-acrylic copolymer and acrylic modifier,
wherein the bio pro-degradent is Ethylene-Vinyl Acetate copolymer with organoleptic additives,
wherein the amount of bio pro-degradent ranges between 0.01% and 20% with respect to the mass of the film, preferably, 0.1% and 10.0% with respect to the mass of the film,
wherein the processing aid is at least one selected from the group consisting of anti-blocking/slipping agents, antistatic agents, lubricants, release agents, anti-sticking agents and melt strength/viscosity balancing agents, and wherein the stabilizer is at least one selected from the group consisting of polymer and soyabean stabilizer,

14. The film as claimed in claim 13, wherein the PVC film is rigid.

15. A blister container for packing pharmaceutical products made using the film in accordance with claim 13.
